(19) United States
(12) Patent Application Publication
(10) Pub. No.: US 2026/0210434 A1
(43) Pub. Date: Jul. 23, 2026

(54) LOCKING DIFFERENTIAL

(71) Applicant: Tesla, Inc., Austin, TX (US)

(72) Inventors: Corbin Johnston, Palo Alto, CA (US); Venkatakrishna Janakiraman, Santa Clara, CA (US); Benjamin Dellal, San Francisco, CA (US); Matthew Jansen, Austin, TX (US); Ryan Boris, Austin, TX (US); Konstantinos Bourchas, Agia Paraskevi (GR); Charalambos Rafail Vasilopoulos, Agia Paraskevi (GR)

(21) Appl. No.: 19/109,486

(22) PCT Filed: Oct. 16, 2023
(86) PCT No.: PCT/US2023/035242

§ 371 Date: Mar. 6, 2025

Related U.S. Application Data
(60) Provisional application No. 63/380,050, filed on Oct. 18, 2022.

(51) Int. Cl. F16H 48/34; F16H 48/08; F16H 48/24; F16H 48/40

(52) U.S. Cl. CPC F16H 48/34; F16H 48/08; F16H 48/24; F16H 48/40

(57) ABSTRACT

A differential system is provided that includes a housing defining an interior cavity. The housing can have a bore communicating with the interior cavity. A pair of pinion gears can be positioned within the interior cavity and rotatably coupled to the housing. First and second side gears positioned within the interior cavity are in meshing engagement with the pinion gears and rotatably coupled to the housing. A moving member is configured to rotate with the housing and move between an engaged position and a disengaged position. The housing can be drivingly coupled to the first side gear when the moving member is in the engaged position. An electromagnetic actuation coil is positioned so as to not rotate with the housing and is configured to generate a magnetic field so as to cause the moving member to move from the disengaged position to the engaged position.

### CROSS-REFERENCE TO RELATED APPLICATIONS

This application claims priority to U.S. Provisional Patent Application No. 63/380,050, filed Oct. 18, 2022, the entire contents of which is incorporated by reference in its entirety and for all purposes.

### TECHNICAL FIELD

This application relates to locking differentials, and more particularly relates to a locking differential with improved efficiency that has general applicability in many products and industries including vehicles, robots, and manufacturing.

### BACKGROUND

In the context of vehicles, locking differentials (“lockers”) can lock the axles of the vehicle together to provide 100% of available torque to the wheel with traction. Thus, when traction is needed, the axles can be mechanically locked together forcing the wheels to rotate at the same speed. However, during turns, the locking differential needs to operate like an open differential to allow the wheels to rotate at different speeds.

### SUMMARY

In some aspects, the techniques described herein relate to a differential system including: a housing defining an interior cavity; a pair of pinion gears positioned within the interior cavity and rotatably coupled to the housing; first and second side gears positioned within the interior cavity in meshing engagement with the pinion gears and rotatably coupled to the housing; a moving member configured to rotate with the housing and move between an engaged position and a disengaged position, the housing being drivingly coupled to the first side gear when the moving member is in the engaged position; and an electromagnetic actuation coil positioned so as to not rotate with the housing and configured to generate a magnetic field to cause the moving member to move from the disengaged position to the engaged position.

In some aspects, the techniques described herein relate to a differential system, wherein the moving member further includes: a base plate; first wall; and a second wall.

In some aspects, the techniques described herein relate to a differential system, wherein the first wall is longer than the second wall.

In some aspects, the techniques described herein relate to a differential system, wherein the electromagnetic actuation coil does not contact the moving member.

In some aspects, the techniques described herein relate to a differential system, wherein the electromagnetic actuation coil further does not contact the housing.

In some aspects, the techniques described herein relate to a differential system, wherein the moving member is separated from the electromagnetic actuation coil by a gap when the moving member is in the engaged position and the disengaged position.

In some aspects, the techniques described herein relate to a differential system, wherein the gap is between 0.1 mm and 2 mm when the moving member is in the engaged position.

In some aspects, the techniques described herein relate to a differential system, wherein the gap is between 3 mm and 7.5 mm when the moving member is in the disengaged position.

In some aspects, the techniques described herein relate to a locking differential system including: a plurality of rotating components including: a housing defining an interior cavity; a first side gear and a second side gear positioned within the interior cavity; and a moving member configured to move between a differential lock position and a differential unlock position; a plurality of non-rotating components including: an electromagnetic actuation component that does not contact the plurality of rotating components; wherein the electromagnetic actuation component interacts with the moving member, causing the moving member to move between the differential lock position and the differential unlock position; wherein the first side gear is locked relative to the second side gear when the moving member is in the differential lock position.

In some aspects, the techniques described herein relate to a locking differential system, wherein the electromagnetic actuation component includes a first actuation face and the moving member includes a first moving member face that is opposite to the first actuation face; and wherein there is a gap between the first moving member face and the first actuation face.

In some aspects, the techniques described herein relate to a locking differential system wherein there the gap between the electromagnetic actuation component and the moving member is between 6 and 4 mm in the differential unlock position; and wherein the gap between the electromagnetic actuation component and the moving member is between 2 and 0.1 mm in the differential locked position.

In some aspects, the techniques described herein relate to a locking differential system, wherein the first side gear is connected to a first drive shaft and the second side gear is connected to a second drive shaft.

In some aspects, the techniques described herein relate to a locking differential system, wherein the plurality of rotating components further includes: a cam ring that is connected to the moving member; wherein the cam ring directly engages the first side gear when the moving member is in the differential lock position.

In some aspects, the techniques described herein relate to a locking differential system, wherein the moving member is made of a ferromagnetic metal.

In some aspects, the techniques described herein relate to a locking differential system including: a housing defining an interior cavity, the housing having an axis of rotation; a first gear and a second gear positioned within the interior cavity and rotatable about the axis of rotation; a moving member configured to rotate with the housing and move in a direction parallel to the axis of rotation; and an attraction element configured to move the moving member; wherein the attraction element does not contact the moving member.

In some aspects, the techniques described herein relate to a locking differential system, wherein the attraction element does not contact the housing, the first gear, or the second gear in both a differential lock state and a differential unlocked state.

In some aspects, the techniques described herein relate to a locking differential system, wherein the moving member includes a first wall configured to interact with the attraction element.

In some aspects, the techniques described herein relate to a locking differential system, wherein the moving member further includes a second wall configured to interact with the attraction element.

In some aspects, the techniques described herein relate to a locking differential system, wherein the first wall is longer than the second wall.

In some aspects, the techniques described herein relate to a locking differential system, wherein the first wall and the second wall at least partially surround the attraction element when the differential is in a locked state.

### BRIEF DESCRIPTION OF THE DRAWINGS

The present inventions are described with reference to the accompanying drawings, in which like reference characters reference like elements, and wherein:

FIG. 1 is a representation of a differential that has a differential in-drive unit in accordance with aspects of the present disclosure.

FIG. 2 illustrates an alternative view of the differential in-drive unit from FIG. 1.

FIG. 3 illustrates an alternative view of the differential in-drive unit from FIG. 1.

FIG. 4A illustrates a more detailed view of the differential in-drive unit, in particular a portion of the rotating locking assembly of the differential in-drive unit.

FIG. 4B illustrates an alternative view of the differential in-drive unit of FIG. 4A.

FIG. 5 illustrates a view of the differential in-drive unit located within the differential housing in an un-locked state.

FIG. 6A illustrates an embodiment of the differential in-drive unit in a locked state.

FIG. 6B illustrates an alternative embodiment of the differential in-drive unit in a locked state.

FIG. 7A is an illustration of an electromagnetic actuation coil.

FIG. 7B is an alternative view of the electromagnetic actuation coil from FIG. 7A showing an integrated connector.

FIG. 8 is an illustration of the electromagnetic actuation coil.

FIG. 8A illustrates a portion of the electromagnetic actuation coil.

FIG. 8B illustrates a portion of the electromagnetic actuation coil, specifically a sensor body and a PWM controller housing.

FIG. 8C illustrates a portion of the electromagnetic actuation coil, specifically the integrated connector.

FIG. 9A illustrates the solenoid coil housing of the electromagnetic actuation coil.

FIG. 9B illustrates the solenoid coil housing and tabs.

FIG. 10 illustrates the solenoid coil of the electromagnetic actuation coil.

FIG. 11A shows a solenoid connector portion after winding.

FIG. 11B shows the solenoid connector portion after the IDC pins have been installed.

FIG. 11C shows the solenoid connector portion after the winding posts and excess wire have been trimmed.

FIG. 12A illustrates an exploded view of the solenoid coil and the solenoid coil housing.

FIG. 12B illustrates the same components as FIG. 12A in an assembled state.

FIG. 13A illustrates an alternative view of the solenoid coil and the solenoid coil housing seen in FIG. 12B.

FIG. 13B illustrates the heat stake as seen in FIG. 13A after it has undergone the heat staking operation.

FIG. 14A illustrates the components of the over molding assembly.

FIG. 14B illustrates the over molding assembly with the over molding material.

FIG. 15A illustrates a primary PCB and a sensor assembly.

FIG. 15B illustrates the assembled primary PCB and the sensor assembly of FIG. 15A placed into the electromagnetic actuation coil as indicated by the arrow.

FIG. 15C illustrates the PWM controller housing cover and the over molding assembly.

FIG. 16A illustrates a detailed view of a portion of the differential in-drive unit in an unlocked state.

FIG. 16B illustrates a detailed view of a portion of the differential in-drive unit in a locked state.

### DETAILED DESCRIPTION

Generally described, one or more aspects of the present disclosure relate to a locking differential and a locking mechanism for the differential. The locking differential disclosed herein has general applicability in many products and industries including vehicles, robots, manufacturing, aerospace, and industrial. For ease of description, the locking differential will be described in the context of vehicles and more specifically in the context of electric vehicles. However, the application of the locking differential disclosed herein is not limited to vehicles and has applicability in many industries.

Traditional approaches to a locking differential mount a stationary actuation coil to the rotating differential housing which leads to parasitic drag. This increase in parasitic drag creates a less efficient differential. Inefficiencies such as this are exacerbated in electric vehicles where range is important.

To address some of the deficiencies associated with a traditional locking differential, the present disclosure describes a locking differential, and components thereof, that have less parasitic drag than traditional locking differentials.

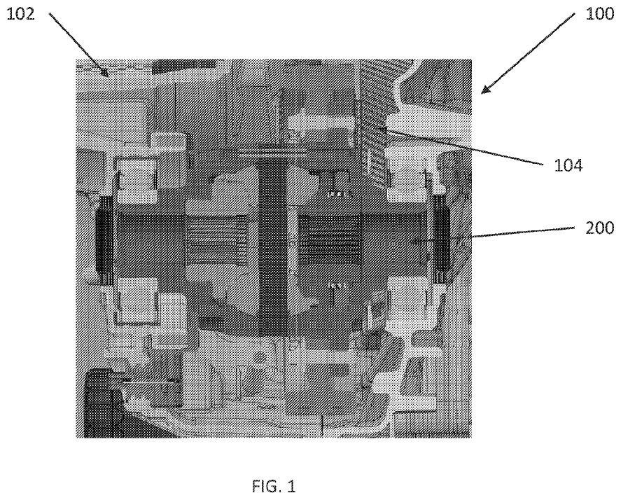

FIG. 1 is a representation of a differential 100 in accordance with aspects of the present application. In certain embodiments, the differential 100 comprises a differential housing 102 defining an interior cavity. In certain embodiments within the differential housing 102 the differential 100 further comprises a ring gear 104 and a differential in-drive unit 200. In certain embodiments, the differential housing 102 is fixed to an associated vehicle. In certain embodiments, within the differential housing 102, the ring gear 104 and the differential in-drive unit housing 202, of the differential in-drive unit 200, rotate. In certain embodiments, the ring gear 104 and the differential in-drive unit 200 may be indirectly or directly mechanically connected. In certain embodiments, the differential in-drive unit 200 is mechanically connected directly or indirectly to an axle so as to drive the wheels of the associated vehicle.

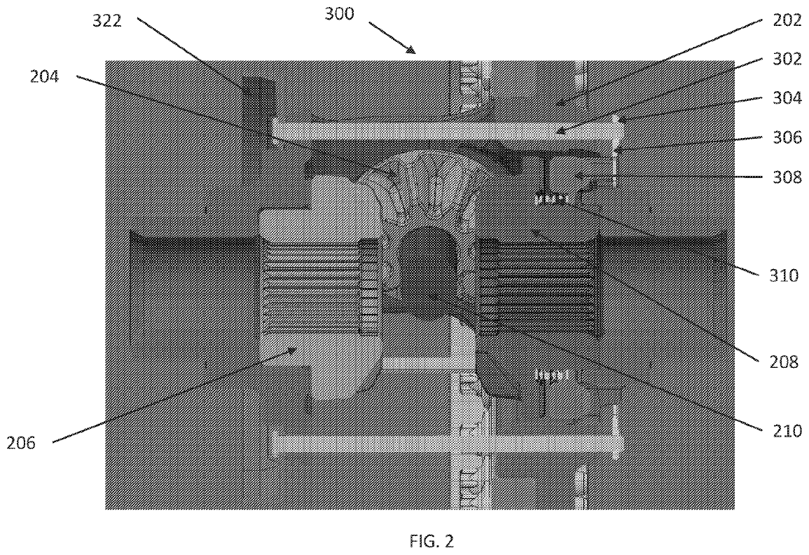

FIG. 2 illustrates an alternative view of the differential in-drive unit 200. In certain embodiments, the differential in-drive unit 200 comprises a differential in-drive unit housing 202. In certain embodiments within the differential in-drive unit housing 202 the differential in-drive unit 200 comprises at least one pinion gear 204, a non-locking side gear 206, and a locking side gear 208. In the illustrated embodiment, the differential in-drive unit housing 202 comprises 2 pinion gears 204, however only one is shown in FIG. 2 for clarity. The pinion gear 204 rotates with the cross shaft 210. The pinion gear 204 may mechanically connect with and or interact with the non-locking side gear 206 and the locking side gear 208, creating a mechanical connection between the non-locking side gear 206 and the locking side gear 208. The non-locking side gear 206 may be connected to a first vehicle axle associated with a first side of the vehicle. The locking side gear 208 may be connected to a second axle associated with a second side of the vehicle.

In certain embodiments, the differential in-drive unit 200 further comprises a rotating locking assembly 300. In certain embodiments, the rotating locking assembly 300 comprises various components associated with the locking differential. When actuated, the rotating locking assembly 300 locks the position of the locking side gear 208 within the differential in-drive unit housing 202. When the locking side gear 208 is in a fixed position relative to the differential in-drive unit housing 202, the non-locking side gear 206 is also in a fixed position relative to the differential in-drive unit housing 202, and as such the first axle associated with a first side of the vehicle is locked in relation to a second axle associated with a second side of the vehicle.

In certain embodiments, the rotating locking assembly 300 comprises one or more actuation pins 302. In certain embodiments, the actuation pins 302 can be held in place by the actuation pin retaining plate 304. In certain embodiments, the actuation pins 302 and/or the actuation plate 304 may be mechanically connected directly or indirectly to the cam plate 306 such that the actuation pins 302 and/or the actuation pin retain plate 304 may push or pull on the cam plate 306 to actuate the rotating locking assembly 300. In certain embodiments, the cam plate 306 is mechanically connected to the cam ring 308 such that the cam plate 306 may push or pull the cam ring 308 when the rotating locking assembly 300 is actuated. The actuation pins 302 and/or the actuation plate 304 may be mechanically connected directly or indirectly to the cam ring 308.

In certain embodiments, the rotating locking assembly 300 comprises a return spring 310. In certain embodiments, the return spring 310 biases the differential 100 into a non-actuated or un-locked state. The return spring 310 may be mechanically connected directly or indirectly to the cam ring 308, so that the return spring 310 pushes or pulls against the cam ring 308 to bias it towards the unlock or non-actuated state. When the rotating locking assembly 300 is in an actuated state, the cam ring 308 is engaged with the locking side gear 208. When the locking side gear 208 and the cam ring 308 are engaged, their positions are fixed relative to one another and in turn the position of both the cam ring 308 and the locking side gear 208 are fixed in relation to the differential in-drive unit housing 202.

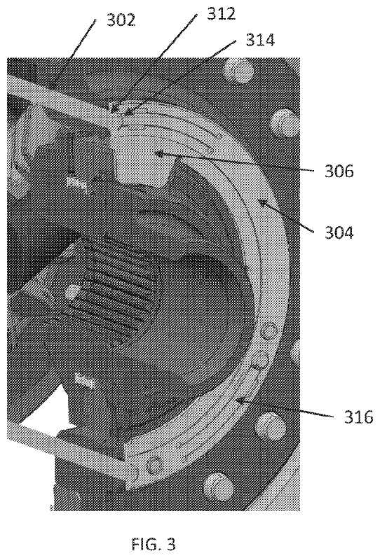

FIG. 3 illustrates an alternative view of the differential in-drive unit 200. As described above, the differential in-drive unit 200 comprises a rotating locking assembly 300. In certain embodiments, the rotating locking assembly 300 comprises at least one actuation pin 302 which is connected to the actuation pin retaining plate 304. In certain embodiments, the actuation pin 302 includes an end portion 312. In certain embodiments, the end portion 312 can include a connecting feature 314. In certain embodiments, the connecting feature 314 is configured to engage the actuation pin retaining plate 304. For example, in certain embodiments, the connecting feature 314 can be a notch that is engaged by the retaining plate 304. The connecting feature 314 may be a concave feature, a convex feature, or any suitable feature. The actuation pin retaining plate 304 may capture, retain, lock, or connect in any suitable manner to the actuation pin 302. The actuation pin retaining plate 304 may be made of a single piece. In certain embodiments, the actuation pin retaining plate 304 is configured to capture multiple actuation pins 302 simultaneously. In certain embodiments, the actuation pin retaining plate 304 includes an engagement feature 316. In certain embodiments, the engagement feature 316 is configured to engage the actuation pin 302, in particular it is configured to engage the connecting feature 314 of the end portion 312 of the actuation pin 302.

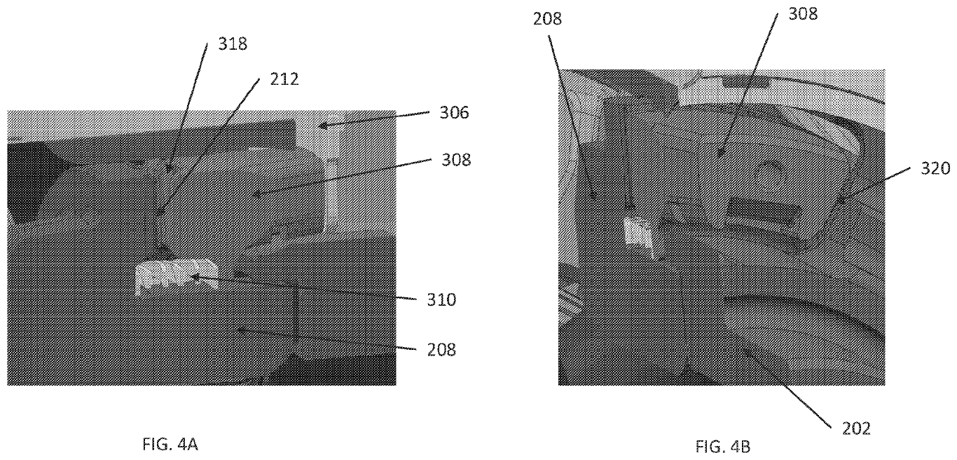

FIG. 4A illustrates a more detailed view of the differential in-drive unit 200, in particular a portion of the rotating locking assembly 300 of the differential in-drive unit 200. In certain embodiments, when the rotating locking assembly 300 is actuated (placed in a locked state) the cam plate 306 pushes against the cam ring 308. In certain embodiments, the cam plate 306 pushes the cam ring 308 towards the locking side gear 208. As the cam ring 308 moves the locking side gear 208, the return spring 310 is compressed. In an actuated position the cam ring 308 engages the locking side gear 208. In certain embodiments, the cam ring 308 comprises a cam plate locking feature 318 that engages with a locking side gear locking feature 212. In certain embodiments, the cam plate locking feature 318 and/or the locking side gear locking feature 212 is configured as a locking face spline.

FIG. 4B illustrates an alternative view of the differential in-drive unit 200 of FIG. 4A. In certain embodiments, the cam ring 308 comprises a torque transmission pawl 320. In certain embodiments, when the cam ring 308 is engaged with the locking side gear 208 in an actuated state, there is a force on the cam ring 308. The torque transmission pawl 320 allows for a transfer of force between the cam ring 308 and the differential in-drive unit housing 202. In certain embodiments, the torque transmission pawl 320 allows for the transfer of force regardless of the direction of spin.

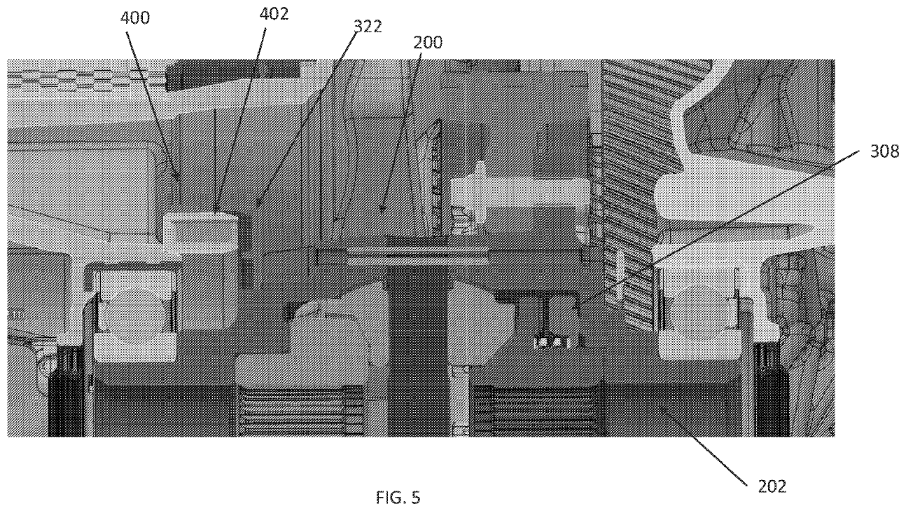

FIG. 5 illustrates a view of the differential in-drive unit 200 located within the differential housing 102 in an un-locked state. In certain embodiments, the differential in-drive unit 200 comprises a rotating locking assembly 300 and a non-rotating locking mechanism 400. In certain embodiments, the rotating locking assembly 300 includes a number of components previously discussed above and may further include an attractive moving plate 322, which may also be referred to as a movable member or the moving member. The attractive moving plate can be made of a ferromagnetic metal, such as iron, cobalt, steel, nickel, manganese, or other material. In certain embodiments, the attractive moving plate 322 is mechanically connected with the actuation pins 302 as shown in FIG. 2. When actuated, the attractive moving plate 322 is pulled towards the electromagnetic actuation coil 402 of the non-rotating locking mechanism 400. The electromagnetic actuation coil 402, which may also be referred to as the attraction element, is fixed in relation to the differential housing 102 and does not rotate during operation. When not actuated, the attractive moving plate 322 does not contact the electromagnetic actuation coil 402, so as to eliminate potential resistance.

In certain embodiments, in the un-locked state there is a gap between the electromagnetic actuation coil 402 and the attractive moving plate 322. In certain embodiments, there is also a gap between the cam ring 308 and the locking side gear 208, more specifically a gap between the locking side gear locking feature 212 and the cam plate locking feature 318. In certain embodiments, in the unlocked state the return spring 310 is in an expanded state.

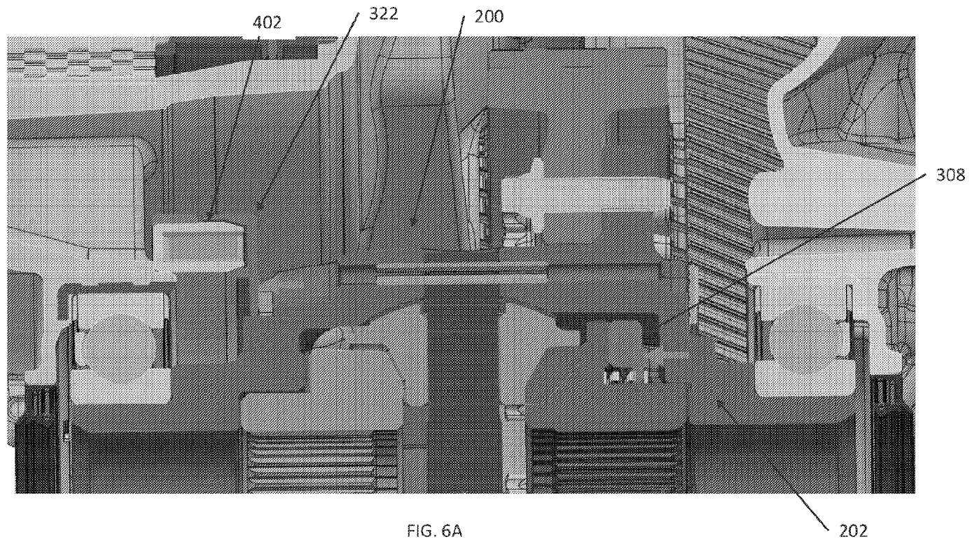

FIG. 6A illustrates a view of the differential in-drive unit 200 in a locked state. In the locked state, the attractive moving plate 322 is pulled towards the electromagnetic actuation coil 402. For example, in certain embodiments, the attractive moving plate 322 moves towards the electromagnetic actuation coil 402. In certain embodiments, the attractive moving plate 322 is mechanically connected to the actuation pins 302, which are mechanically connected to the actuation pin retaining plate 304, which is mechanically connected with the cam plate 306, which is mechanically connected with the cam ring 308. These mechanical connections may be locking, engaging, capturing, or merely a push or pull contact. In certain embodiments, as the attractive moving plate 322 moves towards the electromagnetic actuation coil 402 all of the previously mentioned components which are mechanically connected also move. It should be understood that not all components are required and that components may be omitted. In certain embodiments, when the cam ring 308 is pulled towards the locking side gear 208, the cam plate locking feature 318 is pulled towards the locking side gear locking feature 212. The cam plate locking feature 318 engages the locking side gear locking feature 212. In the locked stated, the locking side gear 208 is fixed in relation to the differential in-drive unit housing 202. In certain embodiments, the locking side gear 208 is mechanically connected to the non-locking side gear 206 through the pinion gear 204. As such when in the locked stated the non-locking side gear 206 is also fixed in relation to the differential in-drive unit housing 202 and the locking side gear 208. As such the respective first side axle associated with the first side of the vehicle and the respective second side axle associated with the second side of the vehicle are fixed.

In the locked state, the attractive moving plate 322 is pulled towards the electromagnetic actuation coil 402. For example, in certain embodiments, the attractive moving plate 322 moves towards the electromagnetic actuation coil 402. In certain embodiments, the attractive moving plate 322 is mechanically connected to the actuation pins 302, which are mechanically connected to the actuation pin retaining plate 304, which is mechanically connected with the cam plate 306, which is mechanically connected with the cam ring 308. These mechanical connections may be locking, engaging, capturing, or merely a push or pull contact. In certain embodiments, as the attractive moving plate 322 moves towards the electromagnetic actuation coil 402 all of the previously mentioned components which are mechanically connected also move. It should be understood that not all components are required and that components may be omitted. In certain embodiments, when the cam ring 308 is pulled towards the locking side gear 208, the cam plate locking feature 318 is pulled towards the locking side gear locking feature 212. The cam plate locking feature 318 engages the locking side gear locking feature 212. In the locked stated, the locking side gear 208 is fixed in relation to the differential in-drive unit housing 202. In certain embodiments, the locking side gear 208 is mechanically connected to the non-locking side gear 206 through the pinion gear 204. As such when in the locked stated the non-locking side gear 206 is also fixed in relation to the differential in-drive unit housing 202 and the locking side gear 208. As such the respective first side axle associated with the first side of the vehicle and the respective second side axle associated with the second side of the vehicle are fixed.

FIG. 6B illustrates a view of an alternative embodiment of the differential in-drive unit 200 in a locked state. The differential in-drive unit 200 may further comprise an anti-attraction plate 324. The anti-attraction plate 324 ma be made of any non-ferrous material, this can include metals such as stainless steel or aluminum. The anti-attraction plate 324 may further be made of nonmetal materials such as plastic or ceramic. The anti-attraction plate 324 can be located between the attractive moving plate 322 and the differential in-drive unit housing 202. In some embodiments, the attractive moving plate 322 may be attracted to the differential in-drive unit housing 202 due to the magnetic forces acting on the attractive moving plate 322. The anti-attraction plate 324 can serve to block, reduce, or mitigate the attractive forced between the attractive moving plate 322 and the differential in-drive unit housing 202.

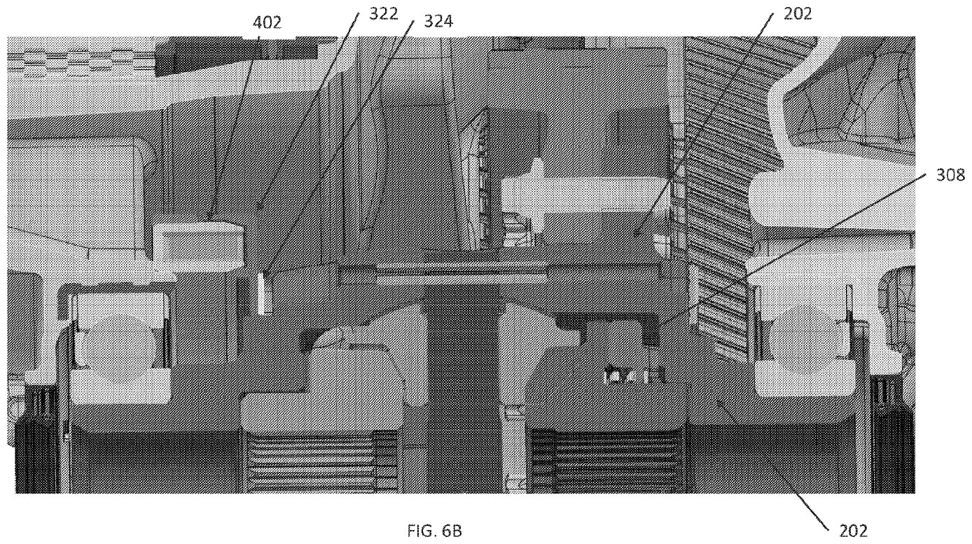

FIG. 7A is an illustration of the electromagnetic actuation coil 402. In certain embodiments, the electromagnetic actuation coil 402 comprises a solenoid coil 500, a pulse-width modulation (PWM) controller housing 406, and a sensor body 408. In certain embodiments, the solenoid coil 500 may sit within or be connected to the electromagnetic actuation coil 402. FIG. 7B is an alternative view of the electromagnetic actuation coil 402 which includes an integrated connector 410.

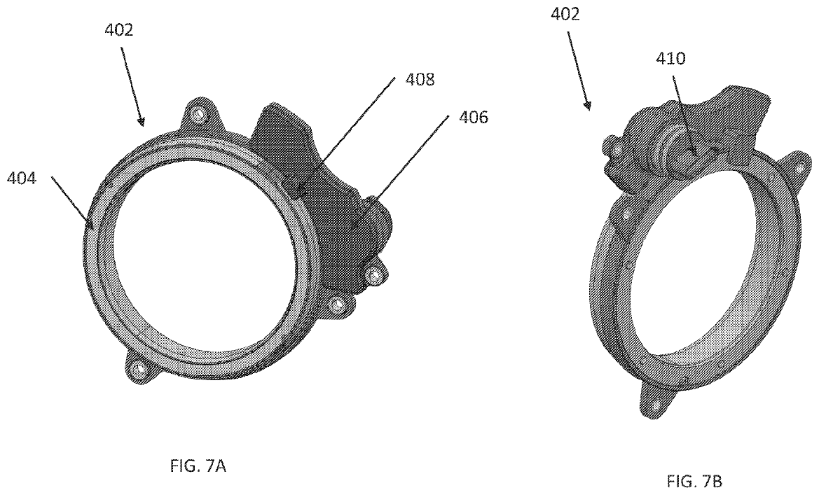

FIG. 8 is an illustration of the electromagnetic actuation coil 402 with cross sectional lines A, B, and C. Cross sectional line A corresponds to FIG. 8A, cross sectional line B corresponds to FIG. 8B, and cross sectional line C corresponds to FIG. 8C.

FIG. 8A illustrates a portion of the electromagnetic actuation coil 402. In certain embodiments, the electromagnetic actuation coil 402 includes an IDC pin 412 and a coil wire 414.

FIG. 8B illustrates a portion of the electromagnetic actuation coil 402, specifically the sensor body 408 and the PWM controller housing 406. In certain embodiments, the electromagnetic actuation coil 402 includes a primary printed circuit board (PCB) 416, a secondary PCB 418, a magnet 420, and a Hall effect IC 422. In certain embodiments, the secondary PCB 418, the magnet 420, and the Hall effect IC 422 are components of the sensor assembly 409.

FIG. 8C illustrates a portion of the electromagnetic actuation coil 402, specifically the integrated connector 410. In certain embodiments, the electromagnetic actuation coil 402 includes a connector body 424, an o-ring 426, and a connector pin 428.

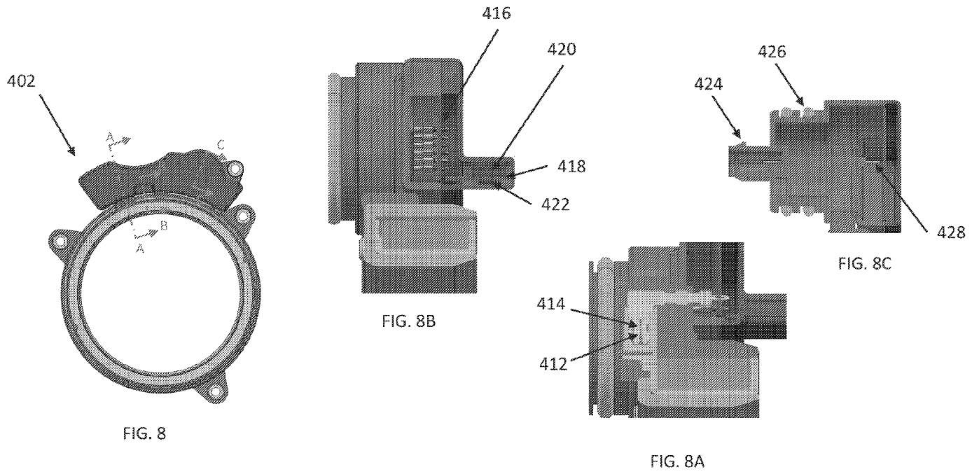

FIG. 9A illustrates the solenoid coil housing 450 of the electromagnetic actuation coil 402. In certain embodiments, the solenoid coil housing 450 may be circular in shape. The solenoid coil housing 450 may be configured to capture, enclose, or partial enclose the solenoid coil 404. In certain embodiments, the solenoid coil housing 450 comprises a first notch 452 and a second notch 454.

As demonstrated in FIG. 9B, the solenoid coil housing 450 can comprise tabs 456. In the illustrated embodiment there are three tabs 456 however there may be more or less. The tabs 456 may comprise a mounting hole 458 through which a screw could fit. The solenoid coil housing 450 may also include a number of heat stake holes 460.

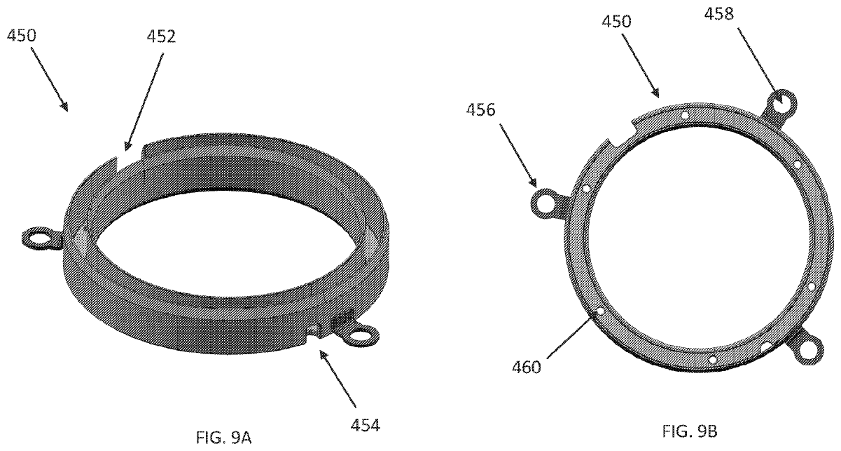

FIG. 10 illustrates the solenoid coil 500 of the electromagnetic actuation coil 402. In certain embodiments, the solenoid coil 500 comprises the coil bobbin 502. In certain embodiments, the coil bobbin 502 may be circular and shaped such that it may hold the coil winding 504. The coil winding 504 may be infused with a thermoplastic, or another bonding or setting agent. The thermoplastic may serve to hold windings of the coil winding 504 in place and or bond them to each other. The thermoplastic may help the windings hold their shape during other manufacturing steps such as injection molding or overmolding. In certain embodiments, the coil bobbin 502 may further comprise heat stakes 506 which are configured to connect with the heat stake holes 460 of the solenoid coil housing 450. In certain embodiments, the solenoid coil 500 further comprises the solenoid connector portion 508.

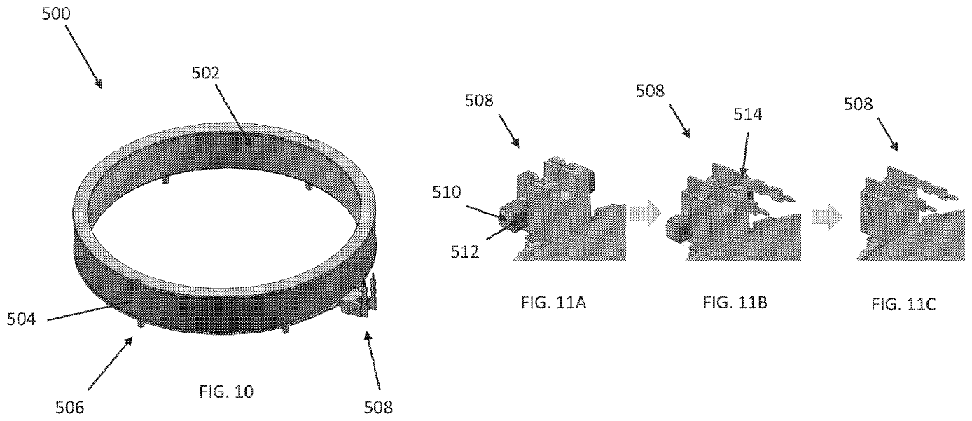

FIGS. 11A-C illustrate a portion of the solenoid coil 500, in particular the solenoid connector portion 508 during the manufacturing process. FIG. 11A shows the solenoid connector portion 508 after winding. In certain embodiments, the solenoid connector portion 508 comprises winding posts 510 and excess wire 512. FIG. 11B shows the solenoid connector portion 508 after the IDC pins 514 have been installed. FIG. 11C shows the solenoid connector portion 508 after the winding posts 510 and excess wire 512 have been trimmed.

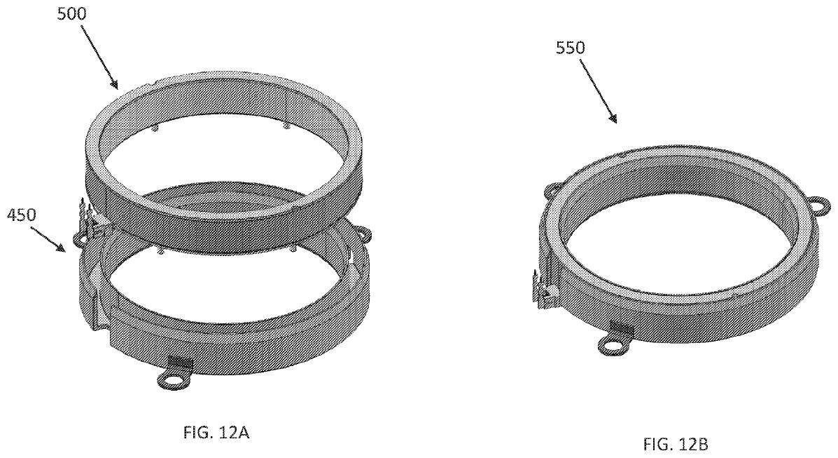

FIG. 12A illustrates an exploded view of the solenoid coil 500 and the solenoid coil housing 450. In certain embodiments, the solenoid coil 500 is partially enclosed by the solenoid coil housing 450. FIG. 12B shows the same components as FIG. 12A, the solenoid coil 500 and the solenoid coil housing 450, in an assembled state, the coil assembly 550.

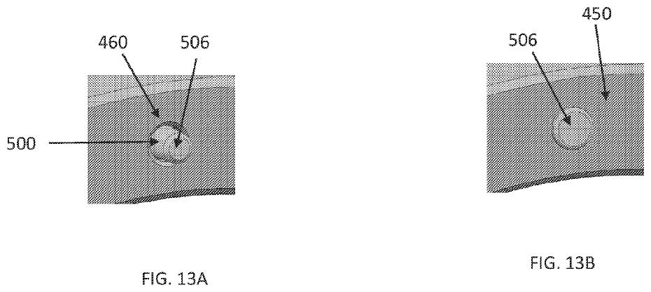

FIG. 13A illustrates an alternative view of the solenoid coil 500 and the solenoid coil housing 450 seen in FIG. 12B. In particular the heat stake 506 is shown passing through the heat stake holes 460 prior to the heat staking operation. FIG. 13B shows the heat stake 506 as seen in FIG. 13A after it has undergone the heat staking operation.

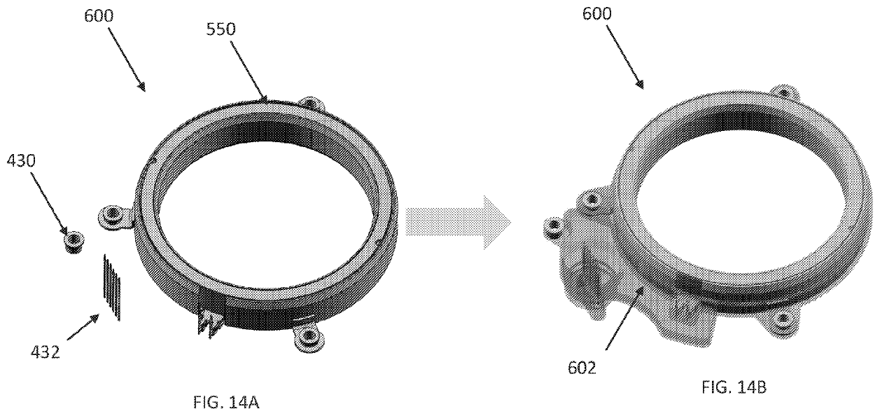

FIG. 14A illustrates the components of the over molding assembly 600. In certain embodiments, the over molding assembly 600 includes the coil assembly 550, one or more crush limiters 430, and the connector pins 432. FIG. 14B illustrates the over molding assembly 600 with the over molding material 602. The over molding material 602 may be PA66, GF30, or any other suitable material. The over molding material 602 fills gaps between the solenoid coil housing 450, the solenoid coil 500, and the other components of the over molding assembly 600.

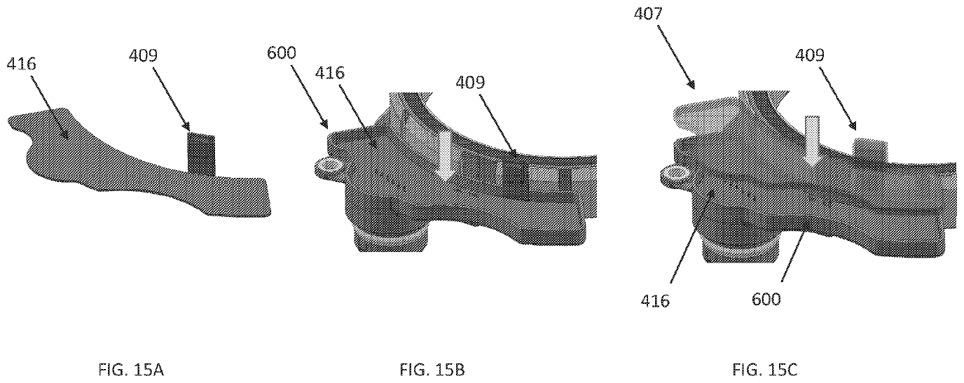

FIGS. 15A-C illustrate an assembly of a portion of the electromagnetic actuation coil 402. FIG. 15A shows the primary PCB 416 and the sensor assembly 409. In certain embodiments, the sensor assembly 409 may be joined to the primary PCB 416 via a press fit connection. FIG. 15B shows the assembled primary PCB 416 and the sensor assembly 409 of FIG. 15A placed into the electromagnetic actuation coil 402 as indicated by the arrow. More specifically the primary PCB 416 and the sensor assembly 409 are placed into the over molding assembly 600. FIG. 15C shows the PWM controller housing cover 407 in addition to the over molding assembly 600. The arrow seen in FIG. 15C indicates the direction of the cover 407 as it is added to the electromagnetic actuation coil 402. In certain embodiments, the PWM controller housing cover 407 is held in place via a laser weld. In certain embodiments, the laser weld seals the PWM controller housing 406.

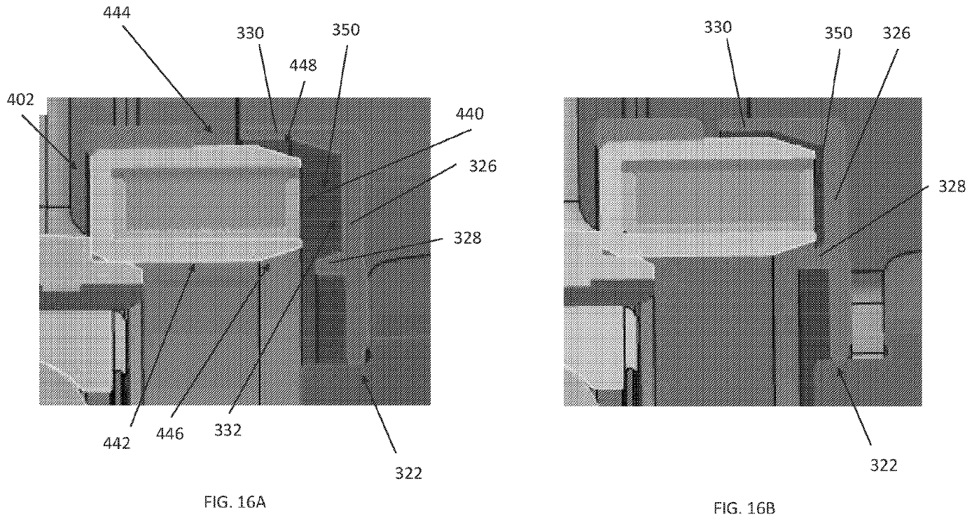

FIG. 16A illustrates a detailed view of an embodiment of the differential in-drive unit 200 in an unlocked state and FIG. 16B illustrates a detailed view of an embodiment of the differential in-drive unit 200 in a locked state. The attractive moving plate 322 can be a circular plate comprising a base plate 326, a first wall 328, and a second wall 330. The first wall 328 can be shorter than the second wall 330. The electromagnetic actuation coil 402 may comprise a top side 440 that faces an inside surface 332 of the base plate 326. The electromagnetic actuation coil 402 may further comprise an inner ring side 442 and an outer ring side 444. The inner ring side 442 may comprise a first chamfered transition 446 on the edge of the inner ring side 442 next to the top side 440. The outer ring side 444 may comprise a second chamfered transition 448 on the edge of the outer ring side 444 next to the top side 440. The attractive moving plate 322 is separated from the electromagnetic actuation coil 402 by a gap. The portion of the gap between the top side 440 and the inside surface 332 may be referred to as a measured gap 350. The measure gap 350 may be around 5.25 mm in the unlocked position, or may be between 5 mm and 5.5 mm, 4.5 mm and 6 mm, 4 mm and 6.5 mm, 3 mm and 7.5 mm. The measured gap may be around 1.25 mm in the locked position, or may be between 1 and 1.5 mm, 0.5 and 2 mm, or 0.1 mm and 2.5 mm. The attractive moving plate 322 is separated from the electromagnetic actuation coil 402 so that they do not contact in both the locked state and the unlocked state.

The differential in-drive unit 200 may further comprise an anti-attraction plate 324. The anti-attraction plate 324 may be made of any non-ferrous material, this can include metals such as stainless steel or aluminum. The anti-attraction plate 324 may further be made of nonmetal materials such as plastic or ceramic. The anti-attraction plate 324 can be located between the attractive moving plate 322 and the differential in-drive unit housing 202. In some embodiments the attractive moving plate 322 may be attracted to the differential in-drive unit housing 202 due to the magnetic forces acting on the attractive moving plate 322. The anti-attraction plate 324 can serve to block, reduce, or mitigate the attractive forced between the attractive moving plate 322 and the differential in-drive unit housing differential in-drive unit housing 202.

The foregoing disclosure is not intended to limit the present disclosure to the precise forms or particular fields of use disclosed. It should be understood that the components described in this disclosure may be used outside of vehicles. The components described may be applicable in the aerospace, robotic, manufacturing equipment, industrial equipment, or other areas. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed glove box actuation assembly. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including,” “comprising,” “incorporating,” “consisting of,” “have,” “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other. Additionally, all numerical terms, such as, but not limited to, “first,” “second,” “third,” “primary,” “secondary,” “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application.

What is claimed is:

1. A differential system comprising:
a housing defining an interior cavity;
a pair of pinion gears positioned within the interior cavity and rotatably coupled to the housing;
first and second side gears positioned within the interior cavity in meshing engagement with the pinion gears and rotatably coupled to the housing;
a moving member configured to rotate with the housing and move between an engaged position and a disengaged position, the housing being drivingly coupled to the first side gear when the moving member is in the engaged position; and
an electromagnetic actuation coil positioned so as to not rotate with the housing and configured to generate a magnetic field to cause the moving member to move from the disengaged position to the engaged position.

2. The differential system of claim 1, wherein the moving member further comprises:
a base plate;
first wall; and
a second wall.

3. The differential system of claim 2, wherein the first wall is longer than the second wall.

4. The differential system of claim 1, wherein the electromagnetic actuation coil does not contact the moving member.

5. The differential system of claim 4, wherein the electromagnetic actuation coil further does not contact the housing.

6. The differential system of claim 1, wherein the moving member is separated from the electromagnetic actuation coil by a gap when the moving member is in the engaged position and the disengaged position.

7. The differential system of claim 6, wherein the gap is between 0.1 mm and 2 mm when the moving member is in the engaged position.

8. The differential system of claim 6, wherein the gap is between 3 mm and 7.5 mm when the moving member is in the disengaged position.

9. A locking differential system comprising:
a plurality of rotating components comprising:
a housing defining an interior cavity;
a first side gear and a second side gear positioned within the interior cavity; and
a moving member configured to move between a differential lock position and a differential unlock position;
a plurality of non-rotating components comprising:
an electromagnetic actuation component that does not contact the plurality of rotating components;
wherein the electromagnetic actuation component interacts with the moving member, causing the moving member to move between the differential lock position and the differential unlock position;
wherein the first side gear is locked relative to the second side gear when the moving member is in the differential lock position.

10. The locking differential system of claim 9, wherein the electromagnetic actuation component comprises a first actuation face and the moving member comprises a first moving member face that is opposite to the first actuation face; and wherein there is a gap between the first moving member face and the first actuation face.

11. The locking differential system of claim 10 wherein there the gap between the electromagnetic actuation component and the moving member is between 6 and 4 mm in the differential unlock position; and wherein the gap between the electromagnetic actuation component and the moving member is between 2 and 0.1 mm in the differential locked position.

12. The locking differential system of claim 9, wherein the first side gear is connected to a first drive shaft and the second side gear is connected to a second drive shaft.

13. The locking differential system of claim 9, wherein the plurality of rotating components further comprises:
a cam ring that is connected to the moving member;
wherein the cam ring directly engages the first side gear when the moving member is in the differential lock position.

14. The locking differential system of claim 9, wherein the moving member is made of a ferromagnetic metal.

15. A locking differential system comprising:
a housing defining an interior cavity, the housing having an axis of rotation;
a first gear and a second gear positioned within the interior cavity and rotatable about the axis of rotation;
a moving member configured to rotate with the housing and move in a direction parallel to the axis of rotation; and
an attraction element configured to move the moving member;
wherein the attraction element does not contact the moving member.

16. The locking differential system of claim 15, wherein the attraction element does not contact the housing, the first gear, or the second gear in both a differential lock state and a differential unlocked state.

17. The locking differential system of claim 15, wherein the moving member comprises a first wall configured to interact with the attraction element.

18. The locking differential system of claim 17, wherein the moving member further comprises a second wall configured to interact with the attraction element.

19. The locking differential system of claim 18, wherein the first wall is longer than the second wall.

20. The locking differential system of claim 18, wherein the first wall and the second wall at least partially surround the attraction element when the differential is in a locked state.
